(19) United States
(12) Patent Application Publication
(10) Pub. No.: US 2013/0316230 A1
(43) Pub. Date: Nov. 28, 2013

(54) NANOSTRUCTURE SURFACE MODIFIED Cu THIN FILM FOR LITHIUM ION NEGATIVE ELECTRODE APPLICATION

(71) Applicants: Gao Liu, Piedmont, CA (US); Ziyan Zheng, Richmond, CA (US); Xiangyun Song, San Leandro, CA (US); Vincent S. Battaglia, San Anselmo, CA (US)

(72) Inventors: Gao Liu, Piedmont, CA (US); Ziyan Zheng, Richmond, CA (US); Xiangyun Song, San Leandro, CA (US); Vincent S. Battaglia, San Anselmo, CA (US)

(73) Assignee: THE REGENTS OF THE UNIVERSITY OF CALIFORNIA, Oakland, CA (US)

(21) Appl. No.: 13/877,424

(22) PCT Filed: Aug. 12, 2011
(86) PCT No.: PCT/US11/47546

§ 371 Date: Aug. 9, 2013

Related U.S. Application Data
(60) Provisional application No. 61/391,000, filed on Oct. 7, 2010.

(51) Int. Cl. H01M 4/38

(52) U.S. Cl. CPC H01M 4/38
USPC 429/211; 429/220; 148/269

(57) ABSTRACT

A nanostructure on Cu comprising a plurality of Cu(OH)₂ nanofibers wherein the nanofibers are formed by treating the Cu surface with ammonia solution to produce a layer of malachite on the Cu surface and treating the malachite coated Cu with NaOH aqueous solution to convert the malachite layer on the Cu surface into Cu(OH)₂ nanofibers. The nanostructure may be formed on a Cu thin film. The thin film may be a layer of a laminated lithium ion battery.

### CROSS-REFERENCE TO RELATED APPLICATION(S)

This application claims priority to PCT Application PCT/U.S.2011/047546, filed Aug. 12, 2011, which in turn claims priority to and the benefit of U.S. Provisional Application Serial No. 61/391,000, entitled “NANOSTRUCTURE SURFACE MODIFIED CU THIN FILM FOR LITHIUM-ION NEGATIVE ELECTRODE APPLICATION,” filed on Oct. 7, 2010, which is expressly incorporated herein by reference in its entirety.

### STATEMENT REGARDING FEDERALLY SPONSORED RESEARCH OR DEVELOPMENT

This invention was made with government support under Contract No. DE-AC02-05CH11231 awarded by the United States Department of Energy to The Regents of the University of California for management and operation of the Lawrence Berkeley National Laboratory. The government has certain rights in this invention.

### BACKGROUND

1. Field

The present disclosure relates to lithium ion batteries and, more particularly, to nanostructure surface modification of Cu current collector for negative electrode application in lithium ion batteries.

2. Description of Related Art

Lithium ion batteries are a type of rechargeable battery in which lithium ions move between the negative and positive electrode. The lithium ion moves through an electrolyte from the negative to the positive electrodes during discharge, and in reverse, from the positive to the negative electrode during recharge. The electrolyte permeates a binder comprising a polymer and an active form of carbon (e.g., acetylene black, graphite, etc.). The porous polymer and carbon binder is also often referred to as a composite. Most commonly the negative electrode is made of graphite, which material is particularly preferred due to its stability during charge and discharge cycles as it forms solid electrolyte interface layers (SEI) with very small volume change during the charge/discharge cycles. The typical battery includes a negative electrode, formed as a thin layer and laminated, a porous separator layer, and positive electrode, formed as a thin layer and laminated, and electrolyte permeating through the separator and electrodes. In some battery configurations, the 3 layers are rolled up into a cylindrical form and encased in a can. The positive and negative electrodes are typically coated on thin foils. In most cases, the positive electrode is coated on Al foil, whereas the negative electrode is coated on Cu foil.

Lithium ion batteries are finding ever increasing acceptance as power sources for portable electronics such as mobile phones and laptop computers that require high energy density and long lifetime. Such batteries are also finding application as power sources for automobiles, where recharge cycle capability and energy density are key requirements. In this regard, research is being conducted in the area of improved electrodes.

Smooth Cu thin foil film is also widely used as a current collector for negative electrodes in lithium ion cells. Different types of binders have been used as adhesive agents to bind graphite active materials to the Cu surface. However, electrolytes tend to swell the composite binder material, compromising the adhesion between the composite and the Cu surface. Some negative electrode failure can be attributed to delamination of the composite from the surface of the Cu electrode. Additionally, new high-energy electrode materials such as Si or Sn, tend to have a large volume change during charge and discharge phases of use. This volume change causes the delamination of the composite from the Cu current collector.

A common approach to improving adhesion between the Cu and the laminate composite is to rough up the Cu surface on a 1-100 μm scale. The improved adhesion is attributed to mechanical interlocking forces between the Cu current collector and the laminate composite. One approach to roughen the Cu surface is to use an electrolytic process. Using highly adhesive binders is another approach. However, the binder has to be compatible with the negative electrode chemistry.

### SUMMARY

A structure and method is disclosed to improve adhesion to Cu surfaces. In an exemplary application to lithium ion batteries, this may provide an improved binding of laminates to copper negative electrodes.

In one embodiment, a nanostructure on Cu comprising a plurality of Cu(OH)₂ nanofibers wherein the nanofibers is formed by treating the Cu surface with ammonia solution to produce a layer of malachite on the Cu surface and treating the malachite coated Cu with NaOH aqueous solution to convert the malachite layer on the Cu surface into Cu(OH)₂ nanofibers.

In a second embodiment, a method of forming a nanostructure on Cu including a plurality of Cu(OH)₂ nanofibers comprises treating the Cu surface with ammonia solution to produce a layer of malachite on the Cu surface and treating the malachite coated Cu with NaOH aqueous solution to convert the malachite layer on the Cu surface into Cu(OH)₂ nanofibers.

In another embodiment, a lithium ion battery is disclosed comprising a Cu thin film foil current collector electrode on which nanofibers are formed to improve adhesion between the Cu current collector electrode and the composite laminate.

### BRIEF DESCRIPTION OF THE DRAWINGS

FIG. 1 illustrates a process for modifying the surface of Cu to form nanofibers;

FIGS. 2 A-B schematically show a copper substrate before and after formation of nanofibers;

FIGS. 3A and 3B show SEM micrographs of nanofibers after treatment with NaOH for 1 minute and 5 minutes, respectively.

FIG. 4 shows adhesion strength peel test results for (A) bare Cu, (B), a rough micron sized malachite growth surface, and (C) a nanofiber Cu(OH)₂ surface treated for 1 minute with NaOH

FIG. 5 illustrates a process for providing a Lithium ion battery including a Cu electrode having nanofibers formed thereon.

### DETAILED DESCRIPTION

Various aspects of the present invention will be described herein with reference to drawings that are schematic illustrations of idealized configurations of the present invention. As such, variations from the shapes of the illustrations as a result, for example, manufacturing techniques and/or tolerances, are to be expected.

Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element. In addition, when a first element is “coupled” to a second element, the first element may be directly connected to the second element or the first element may be indirectly connected to the second element with intervening elements between the first and second elements.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower” can therefore encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

A structure and method is disclosed to modify the surface topology of Cu by growing nanostructures on Cu surfaces. The method may be applied to improve adhesion to the Cu surface. In an exemplary application to lithium ion batteries, this may provide an improved binding of laminates to copper negative electrodes, however, the method may be applied to Cu for various other applications contemplated where improved adhesion is desired.

The method disclosed enhances the Van der Waals force between the laminate and modified Cu surface, because Van der Waals force is proportional to contact surface area between the two components. The method comprises inducing the growth of nanofiber structures on the Cu surface to greatly increase the surface area between the Cu and the laminate, thus increasing the net Van der Waals force and improving the adhesion.

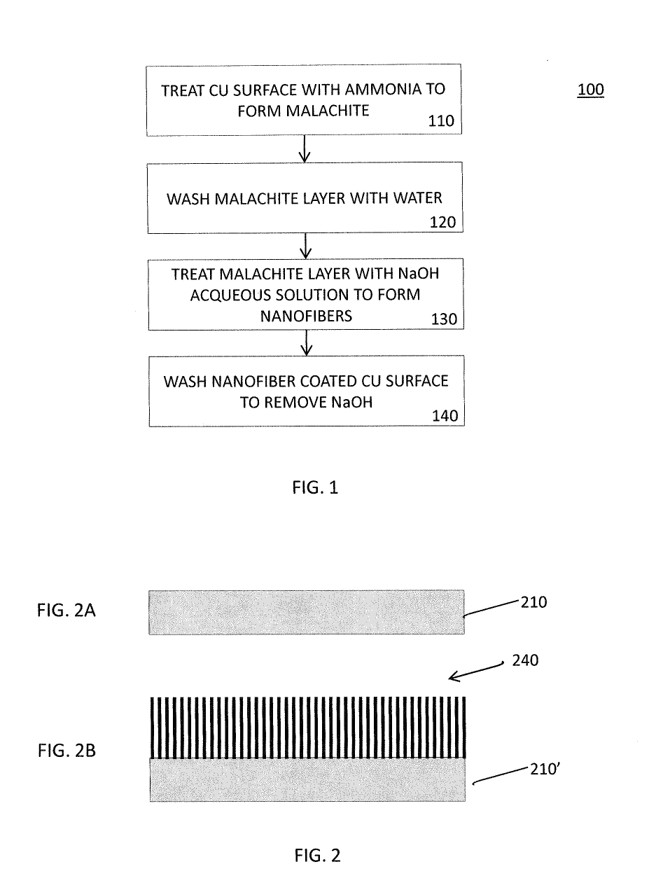

FIG. 1 illustrates a process 100 of modifying the surface of Cu to form nanostructures. A Cu surface may first be treated with an aqueous solution comprising ammonia (process block 110). Treatment with the ammonia solution causes a layer of malachite [Cu₂CO₃(OH)₂] to form on the Cu surface. The concentration of ammonia in the solution may be in the approximate range between 0.1 M and 15 M. More preferably, the ammonia concentration may be in the approximate range between 8 M and 12 M. Further preferably, the ammonia concentration may be approximately 10 M.

A time duration for treating the Cu surface with the ammonia solution may be greater than 10 seconds. The time duration may be longer or shorter, depending on a desired amount of malachite to be formed and reaction conditions. In one embodiment, a treatment time duration of 8-24 hours may be sufficient.

The treated Cu surface may be washed using a solution substantially comprising water after treatment with ammonia (process block 120).

The malachite layer may then be treated with an aqueous solution comprising NaOH (process block 130). An aqueous solution concentration of

NaOH may be approximately between 0.1 M and 5 M. Preferably, the concentration of NaOH may be approximately between 1 M and 3 M. More preferably, the concentration of NaOH may be approximately 2 M.

A time duration for treating the malachite layer thus formed is approximately between 10 seconds and 2 hours. More preferably, the time duration may be approximately between 10 seconds and 5 minutes. Further preferably, the time duration may be approximately between 30 seconds and 2 minutes. Yet further preferably, the time duration may be approximately 1 minute.

FIGS. 2 A-B show a copper substrate (e.g., foil film) before (210) and after (210′) formation of nanofibers 240.

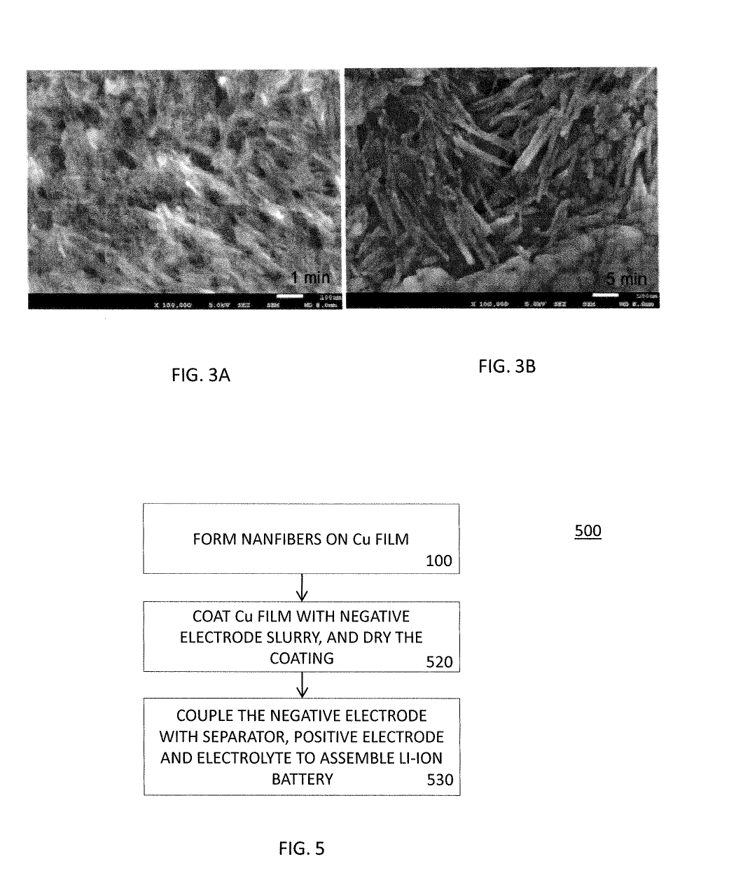

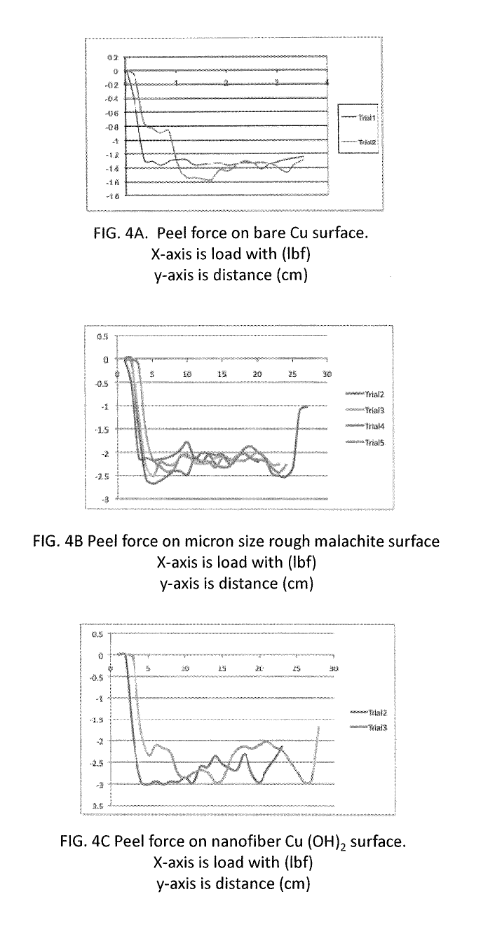

FIG. 3A shows a scanning electron microscope (SEM) micrograph of the Cu surface after 1 minute of treatment with NaOH. FIG. 3B shows a scanning electron microscope (SEM) micrograph of the Cu surface after 5 minute of treatment with NaOH. The 1 minute treatment period produces a much finer nanofiber than the 5 minute treatment period, resulting in a larger surface area, which is important for promoting adhesion between the Cu and the laminate composite in lithium ion batteries. As shown in FIG. 3B, after 5 minutes the Cu(OH)₂ accretes into larger elongated crystal nanorods with uneven morphology on the surface. Adhesion tests were performed to compare the adhesion force of the different Cu surfaces. A scotch tape was used to adhere onto the different surfaces the Cu. The taped Cu was heat treated at 70° C. for 12 hrs under pressure to further improve adhesion. The force to peel off the scotch tape was measured using Chatillon TCD 225 series Force measurement system. The scotch tape is 20 mm wide. The force unit is lbf for all the measurements and the peeling rate is 10. FIGS. 4A-4C show the different peel force measurements for the different surfaces. FIG. 4A is a plot of peel force on a bare Cu surface. FIG. 4B is a plot of peel force on a rough micron sized malachite growth surface. FIG. 4C is a plot of peel force on a nanofiber Cu(OH)₂ surface treated for one minute with NaOH. It clearly shows the nanostructure surface provides better adhesion force compare to bare Cu and micron scale roughed surfaces.

In various embodiments, the Cu may be a thin film, or foil. For some applications, e.g., as an electrode in batteries, the Cu thin film modified to form nanofibers on the Cu surface may be coated with a slurry comprising graphite active material, a binder, conductive additive, and organic solvent. This slurry maybe dried to form a graphite negative electrode laminate on the surface of nanofiber surface modified Cu. This negative electrode may be combined with the separator, positive electrode and electrolyte to form a lithium ion battery. Different types of binder material may be included in the electronic transport material as an adhesive to bind the graphite active material to the Cu surface. The increased surface created by the formation of nanofibers on the Cu surface greatly increases the contact surface area, and therefore also the Van der Waals force binding the graphite active material to the Cu surface. Thus, the adhesive binding of the laminate structure is improved, which may be beneficial to battery performance and lifetime.

FIG. 5 illustrates a process 500 for providing a Lithium ion battery including a modified Cu electrode having nanofibers formed thereon. In process 100 Cu nanofibers are formed on a Cu electrode, such as a foil film, as described in connection with FIG. 1. A negative electrode laminate comprising the modified Cu and binder-graphite is formed (process block 520). A lithium ion battery is then assembled (process block 530), which may include, for example, rolling the laminate into a cylindrical shape and inserting in a can with appropriate contacts to the electrodes.

The various aspects of this disclosure are provided to enable one of ordinary skill in the art to practice the present invention. Modifications to various aspects of forming nanostructures to modify a Cu surface presented throughout this disclosure will be readily apparent to those skilled in the art of batteries, applications to other technical arts, and the concepts disclosed herein may be extended to such other applications. Thus, the claims are not intended to be limited to the various aspects of a lithium ion battery presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of modifying a Cu electrode surface for lithium ion battery application comprising:
treating the Cu electrode surface with a solution comprising ammonia to produce a layer of malachite on the Cu surface; and
treating the malachite coated Cu with an aqueous solution comprising NaOH to convert the malachite layer on the Cu surface into Cu(OH)₂ nanofibers.

2. The method of claim 1 comprising washing the malachite layer coated Cu surface with water before treating the malachite layer with NaOH.

3. The method of claim 1, wherein the Cu electrode is a current collector.

4. The method of claim 1 wherein a time duration for treating the malachite coated Cu with NaOH aqueous solution is approximately 1 minute.

5. The method of claim 1 wherein the Cu is a Cu foil film.

6. The method of claim 5 wherein the Cu foil film is a layer of a laminated lithium ion battery.

7. A nanostructure formed on a Cu electrode surface for a lithium ion battery comprising a plurality of Cu(OH)₂ nanofibers wherein the nanofibers are formed by treating the Cu surface with a solution comprising ammonia to produce a layer of malachite on the Cu surface and treating the malachite coated Cu with an aqueous solution comprising NaOH to convert the malachite layer on the Cu surface into Cu(OH)₂ nanofibers.

8. The nanostructure of claim 7 wherein the malachite layer coated Cu surface is washed with a solution substantially comprising water before being treated with NaOH.

9. The nanostructure of claim 7 wherein Cu electrode is a current collector.

10. The nanostructure of claim 7 wherein a time duration for treating the malachite coated Cu with NaOH aqueous solution is approximately 1 minute.

11. The nanostructure of claim 7 wherein the Cu is a Cu foil film.

12. The nanostructure of claim 11 the Cu foil film is a layer of a laminated lithium ion battery.
